(19) United States
(12) Patent Application Publication
(10) Pub. No.: US 2026/0302798 A1
(43) Pub. Date: Oct. 1, 2026

(54) TEMPERATURE-BASED CONTROL OF BATTERY CHARGER

(71) Applicant: Intel Corporation, Santa Clara, CA (US)

(72) Inventors: Chuen Ming Tan, Bayan Lepas (MY); Venkataramani Gopalakrishnan, Folsom, CA (US); Kunal A. Shah, Bangalore (IN); Venkataramana Kotakonda, Bangalore (IN); Pranav Tipnis, Rancho Cordova, CA (US); Dmitriy Berchanskiy, Rocklin, CA (US); Deepak Ganapathy, Folsom, CA (US); Mark J. Gallina, Hillsboro, OR (US); Aditya Bhutada, Hillsboro, OR (US); Somvir Singh Dahiya, Portland, OR (US)

(21) Appl. No.: 19/091,380

(22) Filed: Mar. 26, 2025

(51) Int. Cl. H02J 7/04; G06F 1/26; H02J 7/00

(52) U.S. Cl. CPC H02J 7/04; G06F 1/263; H02J 7/82; H02J 7/975; H02J 2207/20

(57) ABSTRACT

Embodiments herein relate to battery charger circuitry for a battery-powered computing device. The circuitry can improve the efficiency of a voltage regulator in a battery charger by reducing its input voltage in response to a sensed skin temperature of the computing device exceeding a threshold. The input voltage can be reduced by negotiating a new power level with an external Universal Serial Bus (USB) adapter, for example. The input voltage can be reduced while ensuring that the required power of the device is maintained. The input voltage can also be based on a sensed charge level of the battery in the computing device.

### BACKGROUND

A portable computing device such as a smart phone, tablet or a laptop relies on batteries to provide power to the processor and other components of the device. However, various challenges, including temperature effects, are presented in optimizing the performance of such computing devices.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 depicts plots of central processing unit (CPU) frequency (plot 100) and skin temperature (plots 110 and 120) versus time in a computing device, in accordance with various embodiments.

FIG. 2 depicts an overview of an example computing device 200 with temperature-based control of a battery charger 240, in accordance with various embodiments.

FIG. 3 depicts an example implementation of the battery charger 240 of FIG. 2, in accordance with various embodiments.

FIG. 4A depicts example plots of power loss versus output power for a first type of the battery charger 240 of FIG. 2 for different input voltages, and for a 2S battery, in accordance with various embodiments.

FIG. 4B depicts a table indicating a correspondence between input voltage, power loss and operating mode for the battery charger 240 of FIG. 2, consistent with FIG. 4A, in accordance with various embodiments.

FIG. 5A depicts example plots of power loss versus output power for a second type of the battery charger 240 of FIG. 2 for different input voltages, and for a 2S battery, in accordance with various embodiments.

FIG. 5B depicts a table indicating a correspondence between input voltage, power loss and operating mode for the battery charger 240 of FIG. 2, consistent with FIG. 5A, in accordance with various embodiments.

FIG. 6A depicts example plots of power loss versus output power for the first type of the battery charger 240 of FIG. 2 for different input voltages, and for a 3S battery, in accordance with various embodiments.

FIG. 6B depicts a table indicating a correspondence between input voltage, power loss and operating mode for the battery charger 240 of FIG. 2, consistent with FIG. 6A, in accordance with various embodiments.

FIG. 7A depicts example plots of power loss versus output power for the second type of the battery charger 240 of FIG. 2 for different input voltages, and for a 3S battery, in accordance with various embodiments.

FIG. 7B depicts a table indicating a correspondence between input voltage, power loss and operating mode for the battery charger 240 of FIG. 2, consistent with FIG. 7A, in accordance with various embodiments.

FIG. 8 depicts a flowchart of an example operation for selecting an input voltage for the battery charger 240 of FIG. 2, in accordance with various embodiments.

FIG. 9 depicts a flowchart of an example operation for selecting an input voltage for the battery charger 240 by selecting a power data object (PDO) at the adapter 210, consistent with FIG. 8, in accordance with various embodiments.

FIG. 10 depicts an example circuit 1000 for providing an adjustable voltage supply for the adapter 210, consistent with FIG. 8, in accordance with various embodiments.

FIG. 11 depicts a flowchart of an example operation for operating the platform 220 of FIG. 2 based on a sensed temperature of the platform, in accordance with various embodiments.

FIG. 12 illustrates an example of components that may be present in a computing system 1250 for implementing the techniques (e.g., operations, processes, methods, and methodologies) described herein.

### DETAILED DESCRIPTION

As mentioned at the outset, various challenges are presented in optimizing the performance of computing devices.

The performance of battery-powered computing devices such as laptops or other battery-powered electronic devices is limited by temperature. Such computing devices may receive power from a Universal Serial Bus (USB) adapter which is plugged into an electrical outlet. Such an outlet typically provides 15 A of alternating current (AC) at 120 V, for 1800 W of power. The USB adapter converts the AC current to direct current (DC) at a lower power and voltage level. For example, a USB-C adapter can reduce the voltage to a level such as 5, 9, 15 or 20 V, with 12V optional, in a standard power range, or to 28V, 36V or 48V in an extended power range (EPR). A maximum output current is 3 A or 5 A according to the USB Power Delivery (PD) standard.

In some cases, the USB adapter follows the specifications for an adjustable voltage supply (AVS). Within the EPR mode, AVS enables the sink to fine-tune the voltage between 15V and 48V in steps of 100 mV for improved performance. AVS operates with a power output of 27-240 W. A USB adapter can also provide a programmable power supply (PPS) which allows adjustment of the voltage in 20 mV steps in a lower power output range of 27-100 W.

A battery charger within the device is coupled to the USB adapter, a battery and a processor such as a central processing unit (CPU) and other circuits to be powered within the device. When the adapter is plugged in to an electrical outlet, the battery charger provides power from the adapter to the processor and other circuits, while also charging the battery so that power can also be drawn concurrently from the battery. When the adapter is not plugged in, the battery charger provides power from the battery to the processor and other circuits, thereby discharging the battery.

However, when the central processing unit (CPU) of the device runs at higher frequencies, it consumes more power and generates more heat. Power dissipation increases end-to-end, i.e. upstream from the charger circuit and downstream to voltage regulators and the CPU. In addition, the dissipation of heat depends on the ambient temperature. If the gradient is shallow, i.e., a high ambient environmental temperature, the dissipation from the platform to the environment will be limited, causing a rapid temperature increase. At some point, the temperature will reach a certain threshold when the system enters a thermal survivability mode. In this mode, the system struggles to maintain operation with performance severely impacted.

One potential solution is to improve the charger efficiency by using larger and more robust transistors and other circuit components. Another potential solution is to use larger and more expensive thermal mechanical solutions to improve cooling. However, these approaches are disadvantageous due to increased cost and size.

The solutions provided herein address the above and other disadvantages. In one aspect, the solutions opportunistically improve the efficiency of the battery charger circuitry by optimizing the input voltage to the charger relative to the output voltage by renegotiating a new contract with the USB-C adapter. In one possible approach, the new contract uses the AVS feature of the USB-PD3.2 specification. For adapters not supporting AVS, the fixed supply power data object (PDO) can be used. A feedback loop can be used to monitor the input power to the computing device to ensure that the input voltage optimization does not go below the required power, to maintain system performance. Additionally, when the system is in a skin temperature limit mode, where a sensed temperature at the skin or outer surface of the device is sensed and determined to exceed a threshold, the CPU can reduce its frequency to consume less power. In this mode, the system consumes lesser power, and an opportunity exists to reduce the input voltage of the charger to improve its efficiency.

The solutions provide a number of advantages, including maintaining the performance of laptops and other portable computing devices when operating in a high ambient temperature environment, with the intention to avoid entry to a skin temperature limit mode as much as possible. If entering the skin temperature limit mode is unavoidable due to a severe high ambient temperature, the solutions can delay entry to the mode.

These and other features will be further apparent in view of the following discussion.

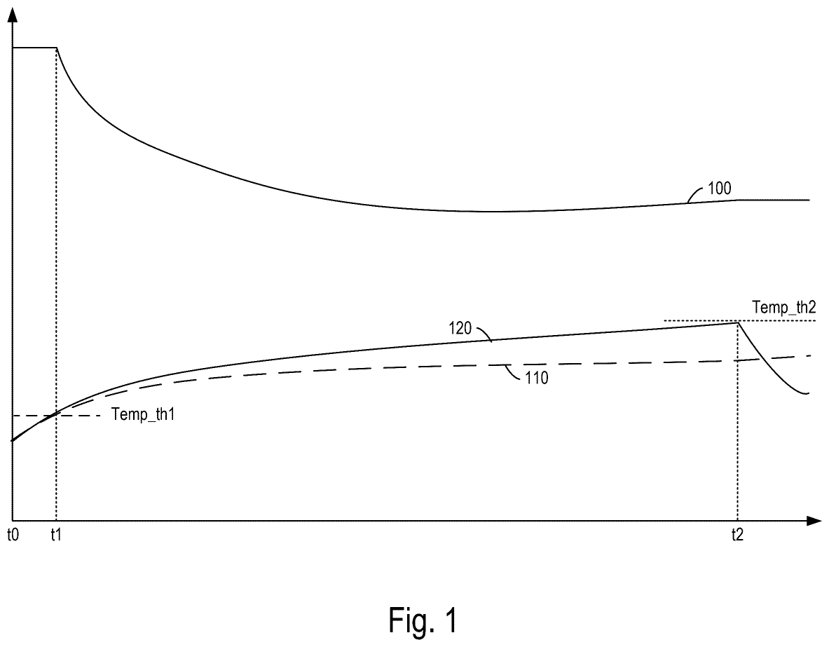

FIG. 1 depicts plots of central processing unit (CPU) frequency (plot 100) and skin temperature (plots 110 and 120) versus time in a computing device, in accordance with various embodiments. Plots 110 and 120 depict the skin temperature with and without the solutions herein, respectively. From t0-t1, the skin temperature is below a first threshold, Temp_th1, such as 45° C. When this skin temperature limit is exceeded at t1, the CPU takes action to lower its operating frequency, e.g., by initiating a frequency reduction of one or more processor cores (plot 100). This slows down the rate of increase of the skin temperature, but the skin temperature can still increase further. This “soft” frequency reduction may be user imperceptible and initiated by the SoC, for example. In contrast, throttling is a severe reduction in frequency when triggered by hardware. For example, throttling can be initiated by a PROCHOT #assertion by hardware that immediately scales frequency drastically to 400 MHz or some value which can cause system to freeze. PROCHOT #is a signal that indicates a processor has reached its maximum safe operating temperature, e.g., Temp_th2.

In particular, as time increases after t1, plot 120 indicates that the temperature continues to build up toward a second threshold, Temp_th2, at t2, despite reducing the CPU frequency. Above this temperature, a temperature survivability mode is reached, where the system must take a drastic action to prevent a brownout, where the processor and other components do not receive enough power to operate normally. The actions can include throttling the processor.

In contrast, with the solutions herein, at plot 110, the temperature builds up at a lower rate than with plot 120. At t2, the temperature survivability mode is avoided or delayed.

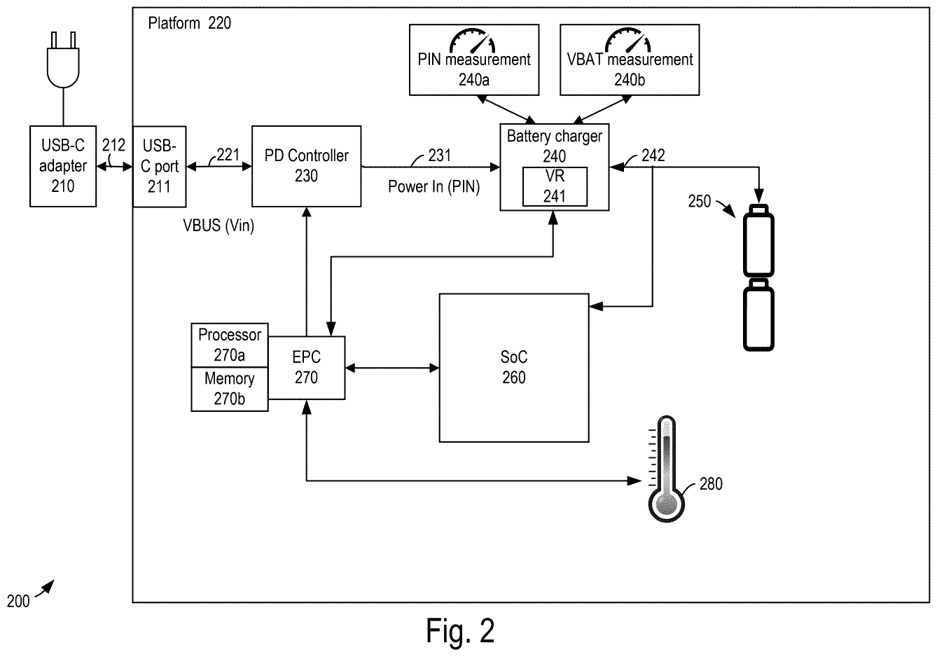

FIG. 2 depicts an overview of an example computing device 200 with temperature-based control of a battery charger 240, in accordance with various embodiments. The computing device includes a power adapter 210 such as a USB-C (USB Type C) adapter which is coupled to a port 211 of a platform 220, e.g., via a cable. 212 The platform includes a power delivery (PD) controller 230 coupled to the port (or integrated into the port), a battery charger 240 coupled to the PD controller, an embedded power controller (EPC) 270 coupled to the PD controller and the battery charger, a system on a chip (SoC) 260, which is an example of a powered circuit in the device, a battery 250 (battery package) which can include one or more battery cells, and a temperature sensor 280 which is coupled to the EPC 270.

The EPC 270 can include a memory 270b, e.g., a non-transitory computer-readable medium, to store instructions and a processor 270a to execute the instructions to provide the features described herein, including instructing the PD controller to renegotiate a power contract with the adapter based on factors such as VBAT, the measured PIN, and the skin temperature relative to one or more thresholds. The EPC can also instruct the SoC to reduce its frequency when the skin temperature exceeds the one or more thresholds. The memory can be configured with different instructions based on the type of battery package and its charge voltage so as to be compatible with different platforms with different battery configurations.

The battery charger 240 and PD controller 230 could each also include a memory to store instructions and a processor to execute the instructions to provide the features described herein,

The power adapter can perform an AC-to-DC conversion and provide power at a specific current and voltage based on a negotiation between the adapter and the PD controller. A USB PD controller is a chip or module that manages the power delivery functionality of USB devices. It enables higher power transfer through USB connections compared to traditional USB standards, like USB 2.0 or 3.0. Its functions can include negotiating power requirements. It can communicate with the adapter and the EC to determine how much power is needed and supported. For example, it can cause the adapter to adjust its output voltage and current based on the capabilities of the device 200. The input power (PIN) from the adapter is provided on a path 221 to the PD controller, which passes the power on to the battery charger via a path 231. The voltage on the path 221 is referred to VBUS (a bus voltage) or Vin and may have one of a few predetermined levels such as 5, 9, 15 or 20V when AVS or PPS is not used, or one of many more granular levels when AVS or PPS is used.

The battery charger includes a voltage regulator 241 (VR) which can operate in a buck, boost or bypass mode, for example, to power the battery 250 and the SoC 260, as an example of a processor or other circuit to be powered, by providing an output power and current on a path 242. In one approach, the VR is a low-dropout regulator integrated into a semiconductor chip. In another possible example, the VR is a switched-capacitor regulator.

The battery charger can include a PIN measurement circuit 240a which measures the level of the input power to the battery power. For example, the PIN measurement circuit can include analog-to-digital converters (ADC) which sense and digitize the input current and voltage on the path 231 to obtain power from P=I*V.

The battery charger can also include a VBAT measurement circuit 240b (a battery charge level measurement circuit or detector), where VBAT is the voltage across the battery. The measurement circuit can use a resistive voltage divider coupled to the positive battery terminal by a dedicated sense wire, for example. An ADC can digitize the voltage.

Note that while the PIN measurement circuit 240a and the VBAT measurement circuit 240b are depicted as being part of the battery charger, they could be separate from the battery charger. The PIN measurement circuit 240a and the VBAT measurement circuit 240b can provide their information to the EPC in one approach to assist the EPC in instructing the PD controller to renegotiate a power contract with the adapter 210.

The temperature sensor 280 can sense a temperature of the skin or outer surface of the computing device, in one approach. The temperature sensor could optionally be part of the battery charger. The temperature sensor can include a small semiconductor-based sensor at the laptop's exterior surface. One or more temperature sensors can be used and can be placed at locations on the skin which are adjacent to components (such as a SoC or other processor) which are expected to become warm. When multiple sensors are used, an average or peak temperature can be compared to a threshold. Potentially, temperatures from different sensors can be compared to different thresholds to guide the control of the battery charger.

The EPC 270 can be a dedicated microcontroller that manages the power distribution within the system, performing tasks such as monitoring voltage levels, adjusting power delivery to different components, and initiating power saving features. The EPC can control functions such as fan control and thermal management based on power usage. The EPC can interact with various sensors throughout the system to monitor temperature, voltage, and current draw, enabling real-time adjustments to power delivery. The EPC can implement features such as dynamic voltage and frequency scaling (DVFS) to reduce power consumption when not under heavy load. The EPC can manage power distribution to different components such as a CPU, graphics processing unit (GPU), random-access memory (RAM), and peripherals, ensuring each receives the appropriate power level. The EPC can also be responsible for managing sleep and wake-up states in a computing device.

The block diagram of the computing device 200 shows power components providing power to the SoC 260 and the battery 260. In an example implementation, assume a 2S battery is used having a fully-charged voltage of about 8.4V. Instead of using Vin=20V, the computing device can select Vin=9V, for example, to improve the efficiency of the battery charger when the skin temperature exceeds a threshold. This lower voltage is acceptable if the total input power drawn does not exceed 9V×3 A=27 W, where 3 A is the assumed maximum current available. The VR 241 can operate in a buck mode to reduce the voltage from 9V on the path 231 to 8.4V on the path 242. In a skin temperature-limited condition, the processor would be constrained from drawing high power as it needs to reduce the CPU frequency to reduce temperature. Hence in this condition, it would be meaningful to reduce the adapter voltage or available power to improve efficiency. Note that when the skin temperature or other temperature metric of the computing device does not exceed a threshold, it is not necessary to reduce Vin. In this case, the nominal full level of Vin can be provided to avoid any reductions in performance.

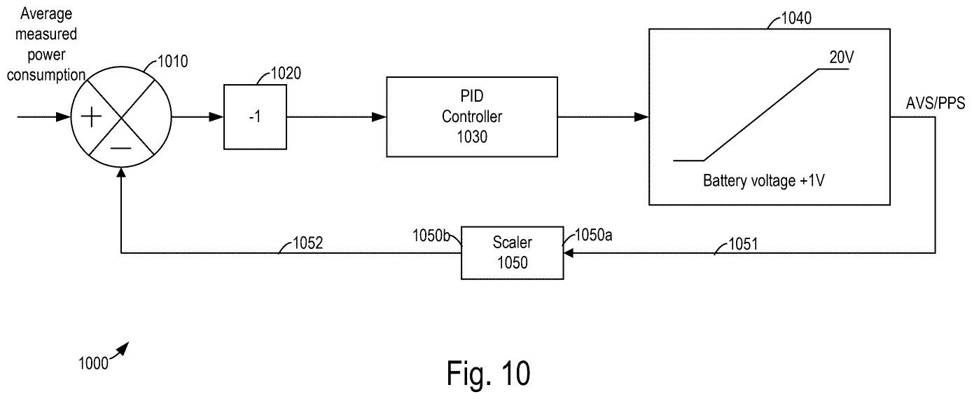

The solutions can use a power monitoring control loop to ensure that the reduction of the input voltage does not result in power deficit. The power monitoring control loop can average out peak power which can vary as it is delivered by the battery. See also FIG. 10.

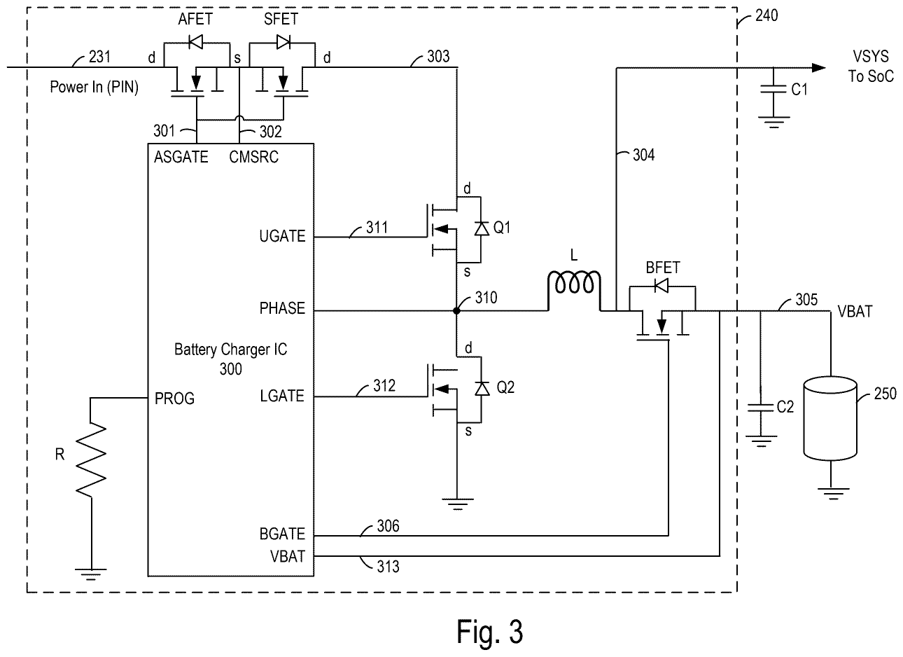

FIG. 3 depicts an example implementation of the battery charger 240 of FIG. 2, in accordance with various embodiments. The battery charger receives VIN on the path 231, as mentioned. Transistors AFET and SFET, e.g., n-type metal-oxide-semiconductor field-effect transistors (MOSFETs), are coupled to the input path in a back-to-back configuration. The transistors have respective drain nodes (d) and a common source node(s).

The battery charger includes an integrated circuit (IC) 300 which is coupled to control gates of AFET and SFET at pin ASGATE via a path 301 to set common control gate voltages. The common source node is controlled by a pin CMSRC via a path 302. An output of SFET is provided on a path 303 to transistors Q1 and Q2 in series, where a source node of Q2 is coupled to ground. Control gates of Q1 and Q2 are controlled via paths 311 and 312, respectively, by pins UGATE and LGATE, respectively. A phase of the voltage at the node 310 between Q1 and Q2 is sensed at the pin PHASE.

The charger can operate as a voltage regulator in a buck or boost mode to provide a desired voltage output at the node 310 by alternately turning on and off the transistors Q1 and Q2. When Q1 is turned on and Q2 is turned off, current is provided from the path 303 to the node 310, and to the inductor L. When Q1 is turned off and Q2 is turned on, current is provided from the node 310 to ground. In a buck mode, the voltage at the node 310 is less than Vin, and in a boost mode, the voltage at the node 310 is greater than Vin. In a bypass mode, the voltage at the node 310 is equal to Vin.

The voltage at the node 310 is passed via the inductor L to a path 304 for output to the SoC or other processor or circuits to be powered, and/or to voltage regulators for such circuits, as a system voltage VSYS. The path 304, which is coupled to ground by a capacitor C1, could alternatively receive power from the battery 250 via the transistor BFET and path 305. BFET is controlled at its control gate via a path 306 and a pin BGATE of the battery charger IC 300. The battery can also receive power via the node 310, BFTET and path 305, which is coupled to ground by a capacitor C2.

The voltage VBAT of the battery can be sensed via a path 313 and a pin VBAT.

The IC 300 can be programmed via a pin PROG coupled to ground by a resistor R.

The battery charger could be configured to operate in a hybrid power boost mode by connecting the paths 303 and 304. In this mode, both the adapter and battery power can be coupled to provide an extra high power output to meet brief high-performance demands.

The charger 300 is an example of a narrow voltage DC (NVDC) charger. This is a type of DC charger that operates within a very small voltage range, designed to optimize charging efficiency and extend battery life by closely tracking the battery voltage throughout the charging process. Other types of chargers could be used as well.

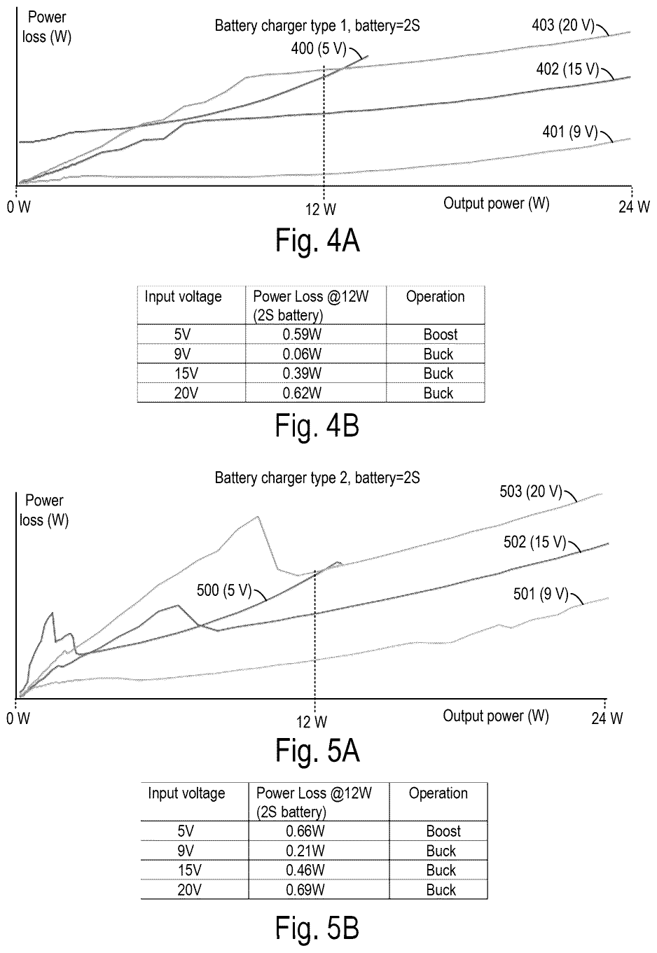

FIGS. 4A-7B involve experiments to determine the power loss reduction of the battery charger when input voltage is optimized for two different brands/models of charger circuits. The experiments show that in a 2S battery system (with a 8.4V full charge voltage), reducing Vin helps reduce power loss until 9V is reached, which results in the lowest power loss. If Vin is reduced further to 5V, for example, the power loss is higher due to the less efficient operation of the charger in boost mode compared to buck mode when Vin=9V. With Vin=9V, the VR 241 operates in a buck mode to decrease the voltage to 8.4V.

Similarly, in a 3S battery system (with a 12.6V full charge voltage), reducing Vin helps reduce power loss until 15V is reached, which results in the lowest power loss. If Vin is reduced further to 9V, for example, the power loss is higher due to the less efficient operation of the charger in boost mode compared to buck mode when Vin=15V. With Vin=15V, the VR 241 operates in a buck mode to decrease the voltage to 12.6V.

The savings in the case of a 3S battery is slightly less than in the case of a 2S battery because the delta between the output and input voltage in the 2S case is narrower than in the 3S case (e.g., 9−8.4=0.6V vs. 15−12.6=2.4V). To improve switching losses in the 3S case, the solution can use the AVS feature in the USB-PD3.2 specification, for example. With AVS, the input voltage can be tuned in small steps such that the input can be brought closer to the output voltage. For example, with the maximum battery voltage of 12.6V in the 3S case, the AVS could tune the voltage below 15V, to 13V, for instance, to further improve efficiency. Ideally, Vin is just above the battery charge level so that the battery charger continues to operate in the buck mode.

The correlation between power savings and skin temperature benefits is highly dependent on chassis construction. Data from various chassis designs indicate that a power savings of 0.5 W and a skin temperature reduction of up to 1° C. are possible. Note that the benefit on CPU SoC die temperatures may be less than the benefit to skin temperature since the SoC typically has a dedicated heat transfer path.

FIG. 4A depicts example plots of power loss versus output power for a first type of the battery charger 240 of FIG. 2 for different input voltages, and for a 2S battery, in accordance with various embodiments. A 2S battery has two battery cells connected in series either end-to-end or side by side. For a Lithium-ion polymer battery, for example, a battery cell may have a maximum voltage of 4.2V when fully charged, a minimum usable voltage of 3.2V, and a nominal voltage midway between the maximum and the minimum of 3.7V. For two battery cells in series, the battery, e.g., battery package, may have a maximum voltage of 8.4, a minimum usable voltage of 6.4V, and a nominal voltage of 7.4V.

Plots 400, 401, 402 and 403 correspond to Vin=5, 9, 15 and 20V, respectively.

When the battery charger operates in a buck or boost mode, it experiences a power loss due to the switching. The switching loss is generally higher when the output power of the battery charger is also higher. The output power ranges from 0-24V in FIGS. 4A, 5A, 6A and 7A. The switching loss is also generally higher when Vin is higher, with some exceptions as indicated by the plots that cross one another.

In this example, the power loss is minimized with Vin=9V across the range of output power. Examples power loss values with an output power of 12 W are listed in FIG. 4B.

FIG. 4B depicts a table indicating a correspondence between input voltage, power loss and operating mode for the battery charger 240 of FIG. 2, consistent with FIG. 4A, in accordance with various embodiments. For Vin=5, 9, 15 or 20V, the power loss with an output power of 12 W is 0.59, 0.06, 0.39 or 0.62 W, respectively, and the operating mode is boost, buck, buck or buck, respectively. The minimum power loss is achieved with Vin=9V, as mentioned. With a maximum battery voltage of 8.4V, Vin=9V is the closest input voltage available in this example which exceeds the battery voltage. A buck mode is used to reduce the 9V to 8.4V. Preferably, Vin is just slightly higher than the battery charge level. As the battery charge level decreases over time, the optimal Vin (which minimizes power loss) could potentially change.

FIG. 5A depicts example plots of power loss versus output power for a second type of the battery charger 240 of FIG. 2 for different input voltages, and for a 2S battery, in accordance with various embodiments.

Plots 500, 501, 502 and 503 correspond to Vin=5, 9, 15 and 20V, respectively.

In this example, the power loss is again minimized with Vin=9V across the range of output power. Examples power loss values with an output power of 12 W are listed in FIG. 5B.

FIG. 5B depicts a table indicating a correspondence between input voltage, power loss and operating mode for the battery charger 240 of FIG. 2, consistent with FIG. 5A, in accordance with various embodiments. For Vin=5, 9, 15 or 20V, the power loss with an output power of 12 W is 0.66, 0.21, 0.46 or 0.69 W, respectively, and the operating mode is boost, buck, buck or buck, respectively. The minimum power loss is again achieved with Vin=9V.

FIGS. 4A-5B show that if the adapter output and charging circuit input is 9V instead of a default value of 20V in a 2S system, the charger circuit could save between about 0.5-0.6 W, a 4% power savings with a 12 W loading.

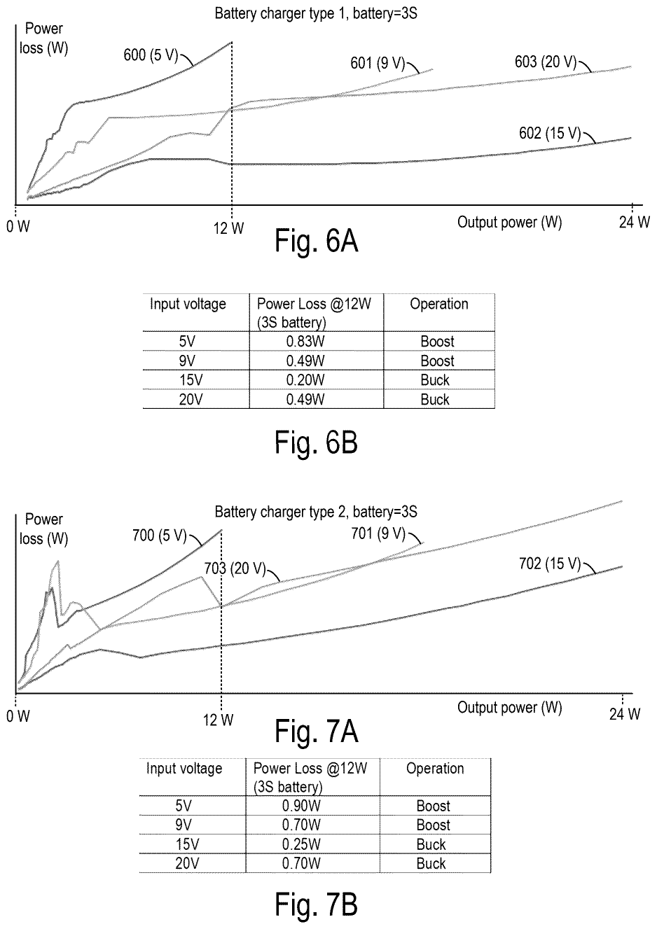

FIG. 6A depicts example plots of power loss versus output power for the first type of the battery charger 240 of FIG. 2 for different input voltages, and for a 3S battery, in accordance with various embodiments. A 3S battery has three battery cells connected in series and may have a maximum voltage of 12.6, a minimum usable voltage of 9.6, and a nominal voltage of 11.1V.

Plots 600, 601, 602 and 603 correspond to Vin=5, 9, 15 and 20V, respectively.

In this example, the power loss is minimized with Vin=15V across the range of output power. Examples power loss values with an output power of 12 W are listed in FIG. 6B. With a maximum battery voltage of 12.6V, Vin=15V is the closest input voltage available in this example which exceeds the battery voltage. A buck mode is used to reduce the 15V to 12.6V.

FIG. 6B depicts a table indicating a correspondence between input voltage, power loss and operating mode for the battery charger 240 of FIG. 2, consistent with FIG. 6A, in accordance with various embodiments. For Vin=5, 9, 15 or 20V, the power loss with an output power of 12 W is 0.83, 0.49, 0.20 or 0.49 W, respectively, and the operating mode is boost, boost, buck or buck, respectively. The minimum power loss is achieved with Vin=15V, as mentioned.

FIG. 7A depicts example plots of power loss versus output power for the second type of the battery charger 240 of FIG. 2 for different input voltages, and for a 3S battery, in accordance with various embodiments.

Plots 700, 701, 702 and 703 correspond to Vin=5, 9, 15 and 20V, respectively.

In this example, the power loss is again minimized with Vin=15V across the range of output power. Examples power loss values with an output power of 12 W are listed in FIG. 7B. With a maximum battery voltage of 12.6V, Vin=15V is the closest input voltage available in this example which exceeds the battery voltage.

FIG. 7B depicts a table indicating a correspondence between input voltage, power loss and operating mode for the battery charger 240 of FIG. 2, consistent with FIG. 7A, in accordance with various embodiments. For Vin=5, 9, 15 or 20V, the power loss with an output power of 12 W is 0.90, 0.70, 0.25 or 0.70 W, respectively, and the operating mode is boost, boost, buck or buck, respectively. The minimum power loss is achieved with Vin=15V, as mentioned.

FIGS. 6A-7B show that if the adapter output and charging circuit input is 15V instead of a default value of 20V in a 3S system, the charger circuit could save between about 0.3-0.4 W, a 3% power savings with a 12 W loading.

FIGS. 4A-7B demonstrate that the specific type of battery charger which is used can be analyzed to determine the Vin which results in the smallest power loss, based on the output power.

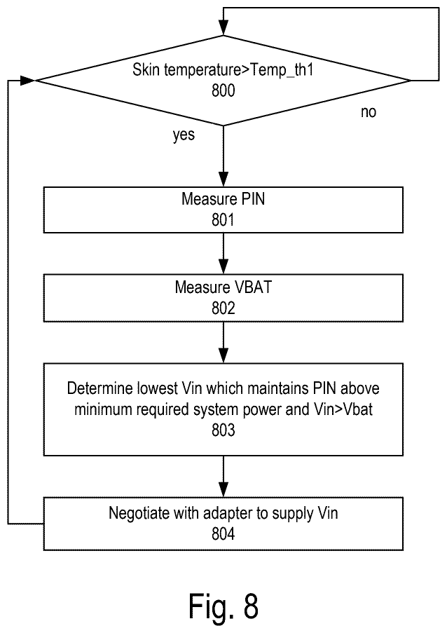

FIG. 8 depicts a flowchart of an example operation for selecting an input voltage for the battery charger 240 of FIG. 2, in accordance with various embodiments. The operation can be performed by the EPC 270, for example. An operation 800 determines whether the skin temperature>Temp_th1, or whether some other indication of a temperature of the computing device exceeds a threshold.

If the answer to the operation 800 is no, the operation 800 is repeated again after a wait period. If the answer to the operation 800 is yes, operation 801 includes measuring the power input (PIN) to the battery charger. For example, see the PIN measurement circuit 240a of FIG. 2. Operation 802 includes measuring the battery voltage VBAT. VBAT can degrade over time. For example, see the VBAT measurement circuit 240b of FIG. 2. Operation 803 includes determining the lowest Vin which maintains PIN above a minimum required system power and Vin>Vbat. Operation 804 includes negotiating with the adapter to supply the determined value of Vin.

As mentioned, one possible approach to the negotiating involves requesting a power data object (PDO) at the adapter 210. Another possible approach to the negotiating involves requesting a voltage using the AVS or PPS specification.

The process of the flowchart can be repeated at fixed intervals, in one possible approach.

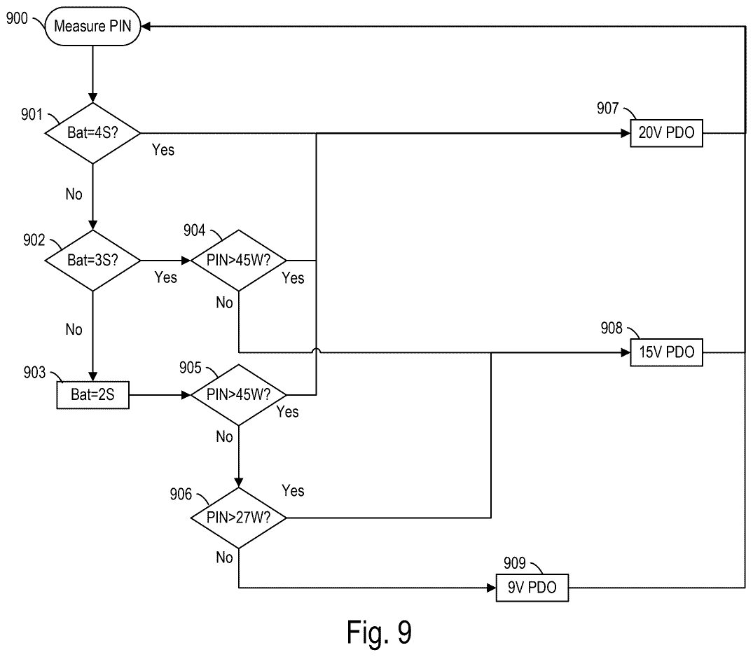

Operation 804 indicates that the benefits in efficiency from reducing Vin should generally not cause a power deficit at the adapter side when system is in operation. To ensure no degradation in performance, the power monitoring circuits in the platform 220 can be monitored continuously, with averaging over a few seconds, for instance. For spike currents, the battery will supplement the power and is accounted for during averaging of power measurement. The flowchart of FIG. 9 selects the right fixed Power data object (PDO), whether it is 20V, 15V, 9V. The input voltage of 5V is not considered in this example as it is less efficient than the other voltages, as discussed above. Furthermore, at 5V very little power is available (5V*3 A=15 W max−efficiency).

FIG. 9 depicts a flowchart of an example operation for selecting an input voltage for the battery charger 240 by selecting a power data object (PDO) at the adapter 210, consistent with FIG. 8, in accordance with various embodiments. Operation 900 involves measuring PIN. Operation 901 determines whether the battery type is 4S. If the answer to the operation 901 is yes, operation 907 indicates that a 20V PDO is requested. If the answer to the operation 901 is no, operation 902 determines whether the battery type is 3S. If the answer to the operation 902 is yes, operation 904 determines whether PIN>45 W. If the answer to the operation 904 is yes, operation 907 indicates that a 20V PDO is requested. If the answer to the operation 904 is no, operation 908 indicates that a 15V PDO is requested.

If the answer to the operation 902 is no, operation 903 indicates that the battery type is 2S and an operation 905 determines whether PIN>45 W. If the answer to the operation 905 is yes, operation 907 indicates that a 20V PDO is requested. If the answer to the operation 905 is no, an operation 906 determines whether PIN>27 W. If the answer to the operation 906 is yes, operation 908 indicates that a 15V PDO is requested. If the answer to the operation 906 is no, operation 909 indicates that a 9V PDO is requested.

The operations indicate that the solution can work with different battery types and different available input voltages. This example assumes that four values of Vin are available, consistent with FIGS. 4A-7B. Additionally, PIN represents the power consumed by the platform, where PIN=Vin*I. Vin should be high enough so that (Vin*I+margin1)>PIN, where margin1=1-5 W, for example. Another criterion is that Vin exceeds the battery package voltage+margin2.

For example, at the operation 904, assume PIN=50 W. With a maximum output current of 3 A, for instance, if Vin=20V, the available power is 20*3=60 W which is sufficient to power the platform. Also, with a 3S battery, assume the battery package voltage is 12.6V. Vin=20V exceeds 12.6V+margin2, where margin2=1-2V, for instance, so this condition is also met.

However, if Vin=15V, the available power is 15*3=45 W which is not sufficient to power the platform. Even though Vin=15V exceeds 12.6V+margin2, this Vin is not acceptable.

As another example, at the operation 906, assume PIN=35 W. With a maximum output current of 3 A, for instance, if Vin=15V, the available power is 15*3=45 W which is sufficient to power the platform. Also, with a 2S battery, assume the battery package voltage is 8.4V. Vin=15V exceeds 8.4+margin2 so this condition is also met. However, if Vin=9V, the available power is 9*3=27 W, which is not sufficient to power the platform.

The voltages and power settings in the flowchart are examples only as other values may be used. Note that the decisions for selecting Vin can vary over time as factors such as PIN and VBAT vary.

FIG. 10 depicts an example circuit 1000 for providing an adjustable voltage supply for the adapter 210, consistent with FIG. 8, in accordance with various embodiments. The circuit includes an adder 1010 which receives an average measured power consumption (e.g., PIN) and subtracts from it a feedback value or power on a path 1052. The output of the adder is provided to a-1 multiplier 1020 which outputs a negative of the input value to a Proportional-integral-derivative (PID) controller 1030. An adjustment circuit 1040 adjusts the output of the PID controller to output an AVS/PPS value of Vin on a path 1051 to a scaler 1050. A scaled value is output on the path 1052. The scaler has an input 1050a coupled to the adjustment circuit 1040 and is configured to convert a voltage into a power, and an output 1050b coupled to the adder 1010. The adder provides an output to the circuit 1020 by subtracting the output of the scaler from the average measured power consumption. The circuit will tend to settle at a value of Vin corresponding to the average measured power consumption.

In this approach, instead of the coarse-grained operation of FIG. 9 in which only a few (e.g., <5-10) selected values of Vin are available, the circuit 1000 can be used in an AVS or PPS system to provide a fine-grained operation in which many (e.g., hundreds) of values of Vin are available. The circuit includes a linear feedback system with the PID controller 1030 to steer the voltage up and down, tracking the battery voltage. There is a saturation on the upper and lower limit of the battery voltage plus a margin such as 1V. 20V is the upper limit in this example, but can be higher such as in Extended Power Range systems (EPR). The lower limit is the current measured battery voltage plus a margin such as 1V. For example, if the battery voltage is 7V, the AVS/PPS voltage will settle at 8V.

Parameters of the PID controller 1030 can be adjusted according to the temperature response. If the loop is too slow, the AVS voltage may frequently hit saturation either at 20V or battery voltage (VBAT)+1V. If the loop is too fast, it may cause an overshoot that result in instability, especially when the averaging of the power consumption is slow. The scaler 1050 converts the AVS voltage into power by multiplying with the maximum capability current of the adapter. For example, if the adapter current max is 3 A and the AVS voltage is 18V, the output of the scaler equals 54 W. This will be compared with the averaged measured power consumption at the adder 1010. If the averaged measured power consumption at a given time is 20 W, for example, then the error is 54 W−20 W=34 W. This error power will drive down the AVS voltage.

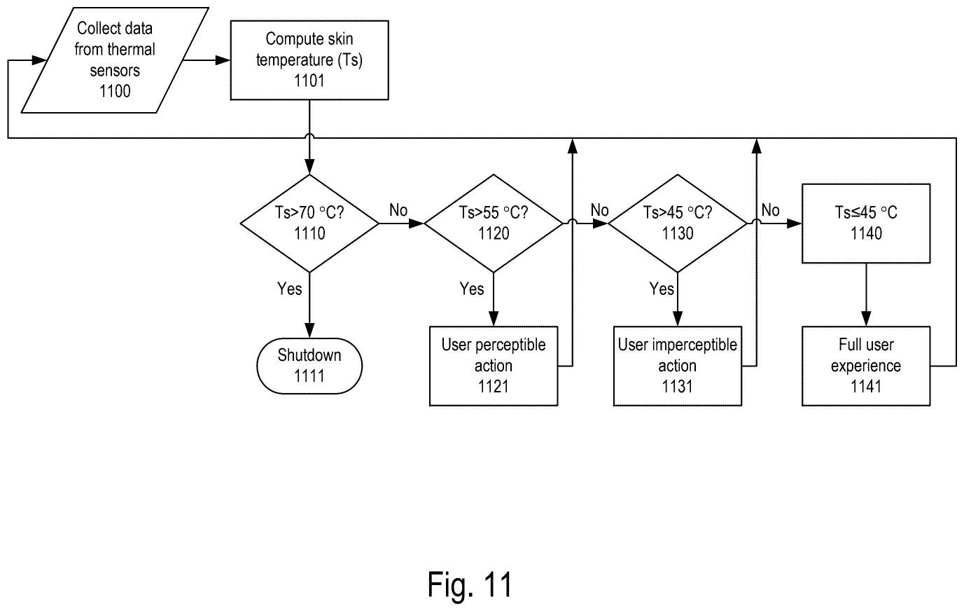

FIG. 11 depicts a flowchart of an example operation for operating the platform 220 of FIG. 2 based on a sensed temperature of the platform, in accordance with various embodiments. Operation 1100 includes collecting data from thermal sensors. Operation 1101 includes computing a skin temperature (Ts) using an appropriate algorithm.

Operation 1110 determines whether Ts>70° C. If the answer to operation 1110 is yes, operation 1111 indicates that the computing system should be shutdown. If the answer to operation 1110 is no, operation 1120 is reached.

Operation 1120 determines whether Ts>55° C. If the answer to operation 1120 is yes, operation 1121 indicates that one or more user-perceptible actions should be taken to reduce power consumption. This could include reducing processor speed significantly, e.g., throttling, so that the performance of the computing device slows down in a noticeable way. For example, video streaming on the device may be noticeably delayed or distorted. Another option is reducing a screen brightness.

If the answer to operation 1120 is no, operation 1130 is reached.

Operation 1130 determines whether Ts>45° C. If the answer to operation 1130 is yes, operation 1131 indicates that one or more user-imperceptible actions should be taken to reduce power consumption. This could include reducing processor speed modestly so that the performance of the computing device slows down but not in a noticeable way. Other options include disabling unnecessary features, enabling power-saving modes, and using sleep or hibernate functions. If the answer to operation 1130 is no, operation 1140 is reached.

Operation 1140 indicates that Ts≤45° C. as a result of which operation 1141 indicates that a full user experience should be provided, where no action is taken to reduce power consumption. This could include running the processor at its normal frequency.

Operations 1100 and 1101 involve sensing operations, operations 1110, 1120, 1130 and 1140 involve temperature thresholds, and operations 1111, 1121, 1131 and 1141 involve actions. When the skin temperature first exceeds 45° C., for example, one or more user-imperceptible actions take place, such as the CPU frequency starting to decrease. This is the point where the solutions herein can work to reduce the rate of increase in the temperature while lowering power consumption through a lower input voltage.

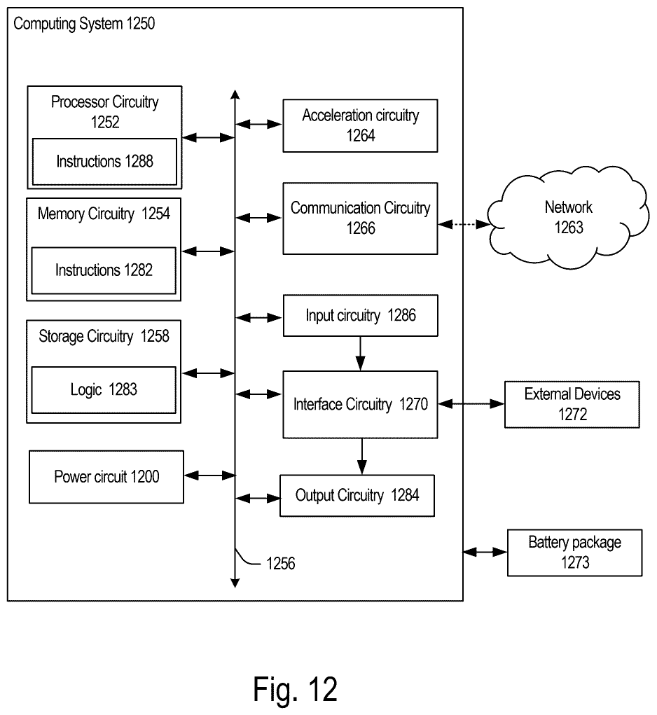

FIG. 12 illustrates an example of components that may be present in a computing system 1250 for implementing the techniques (e.g., operations, processes, methods, and methodologies) described herein.

The computing system 1250 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 1250, or as components otherwise incorporated within a chassis of a larger system. In an example implementation, the power circuit 1200 represents the battery charger 240 and EPC 270, the processor circuitry 1252 represents the SoC 260, the interface circuitry 1270 represents the port 211 and PD controller 230, and the external devices represents the adapter 210.

In one approach, all or part of the computing system 1250 is provided in a SoP, System in Package (SiP) or a System on Chip (SoC).

The voltage regulator can provide a voltage Vout to one or more of the components of the computing system 1250. The memory circuitry 1254 may store instructions and the processor circuitry 1252 may execute the instructions to perform the functions described herein.

The system 1250 includes processor circuitry in the form of one or more processors 1252. The processor circuitry 1252 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1252 may include one or more hardware accelerators (e.g., same or similar to acceleration circuitry 1264), which may be microprocessors, programmable processing devices (e.g., FPGA, ASIC, etc.), or the like. The one or more accelerators may include, for example, computer vision and/or deep learning accelerators. In some implementations, the processor circuitry 1252 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor circuitry 1252 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low-voltage processor, an embedded processor, or any other known processing elements, or any suitable combination thereof. The processors (or cores) 1252 may be coupled with or may include memory/storage and may be configured to execute instructions stored in the memory/storage to enable various applications or operating systems to run on the platform 1250. The processors (or cores) 1252 is configured to operate application software to provide a specific service to a user of the platform 1250. In some embodiments, the processor(s) 1252 may be a special-purpose processor(s)/controller(s) configured (or configurable) to operate according to the various embodiments herein.

As examples, the processor(s) 1252 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1252 may be a part of a system on a chip (SoC), System-in-Package (SiP), a multi-chip package (MCP), and/or the like, in which the processor(s) 1252 and other components are formed into a single integrated circuit, or a single package, such as the Edison™ or Galileo™ SoC boards from Intel® Corporation. Other examples of the processor(s) 1252 are mentioned elsewhere in the present disclosure.

The system 1250 may include or be coupled to acceleration circuitry 1264, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 1264 may comprise logic blocks or logic fabric and other interconnected resources that may be programmed (configured) to perform various functions, such as the procedures, methods, functions, etc. of the various embodiments discussed herein. In such implementations, the acceleration circuitry 1264 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 1252 and/or acceleration circuitry 1264 may include hardware elements specifically tailored for machine learning and/or artificial intelligence (AI) functionality. In these implementations, the processor circuitry 1252 and/or acceleration circuitry 1264 may be, or may include, an AI engine chip that can run many different kinds of AI instruction sets once loaded with the appropriate weightings and training code.

Additionally or alternatively, the processor circuitry 1252 and/or acceleration circuitry 1264 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPs™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1252 and/or acceleration circuitry 1264 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin provided by Huawei®, and/or the like. In some hardware-based implementations, individual subsystems of system 1250 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 1250 also includes system memory 1254. Any number of memory devices may be used to provide for a given amount of system memory. As examples, the memory 1254 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 1254 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 1254 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 1258 provides persistent storage of information such as data, applications, operating systems and so forth. In an example, the storage 1258 may be implemented via a solid-state disk drive (SSDD) and/or high-speed electrically erasable memory (commonly referred to as “flash memory”). Other devices that may be used for the storage 1258 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 1254 and/or storage circuitry 1258 may also incorporate three-dimensional (3D) cross-point (XPOINT) memories from Intel® and Micron®.

The memory circuitry 1254 and/or storage circuitry 1258 is/are configured to store computational logic 1283 in the form of software, firmware, microcode, or hardware-level instructions to implement the techniques described herein. The computational logic 1283 may be employed to store working copies and/or permanent copies of programming instructions, or data to create the programming instructions, for the operation of various components of system 1250 (e.g., drivers, libraries, application programming interfaces (APIs), etc.), an operating system of system 1250, one or more applications, and/or for carrying out the embodiments discussed herein. The computational logic 1283 may be stored or loaded into memory circuitry 1254 as instructions 1282, or data to create the instructions 1282, which are then accessed for execution by the processor circuitry 1252 to carry out the functions described herein. The processor circuitry 1252 and/or the acceleration circuitry 1264 accesses the memory circuitry 1254 and/or the storage circuitry 1258 over the interconnect (IX) 1256. The instructions 1282 direct the processor circuitry 1252 to perform a specific sequence or flow of actions, for example, as described with respect to flowchart(s) and block diagram(s) of operations and functionality depicted previously. The various elements may be implemented by assembler instructions supported by processor circuitry 1252 or high-level languages that may be compiled into instructions 1288, or data to create the instructions 1288, to be executed by the processor circuitry 1252. The permanent copy of the programming instructions may be placed into persistent storage devices of storage circuitry 1258 in the factory or in the field through, for example, a distribution medium (not shown), through a communication interface (e.g., from a distribution server (not shown)), over-the-air (OTA), or any combination thereof.

The IX 1256 couples the processor 1252 to communication circuitry 1266 for communications with other devices, such as a remote server (not shown) and the like. The communication circuitry 1266 is a hardware element, or collection of hardware elements, used to communicate over one or more networks 1263 and/or with other devices. In one example, communication circuitry 1266 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 1266 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 1256 also couples the processor 1252 to interface circuitry 1270 that is used to connect system 1250 with one or more external devices 1272. The external devices 1272 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 1250, which are referred to as input circuitry 1286 and output circuitry 1284. The input circuitry 1286 and output circuitry 1284 include one or more user interfaces designed to enable user interaction with the platform 1250 and/or peripheral component interfaces designed to enable peripheral component interaction with the platform 1250. Input circuitry 1286 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1284 may be included to show information or otherwise convey information, such as sensor readings, actuator position(s), or other like information. Data and/or graphics may be displayed on one or more user interface components of the output circuitry 1284. Output circuitry 1284 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 1250. The output circuitry 1284 may also include speakers and/or other audio emitting devices, printer(s), and/or the like. Additionally or alternatively, sensor(s) may be used as the input circuitry 1286 (e.g., an image capture device, motion capture device, or the like) and one or more actuators may be used as the output circuitry 1284 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 1250 may communicate over the IX 1256. The IX 1256 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 1256 may be a proprietary bus, for example, used in a SoC based system.

The number, capability, and/or capacity of the elements of system 1250 may vary, depending on whether computing system 1250 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 1250 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.
Example 1 includes an apparatus, comprising: a battery charger including an input coupled to a power adapter; a control circuit coupled to the battery charger and the power adapter; a temperature sensor coupled to the control circuit; and a charge-level detector coupled to a battery and to the control circuit.
Example 2 includes the apparatus of Example 1, wherein the control circuit is configured to request that the power adapter decrease its output voltage in response to a temperature sensed by the temperature sensor exceeding a threshold.
Example 3 includes the apparatus of Example 2, wherein: the charge-level detector is configured to monitor a charge voltage of the battery; and the control circuit is configured to request that power adapter decrease its output voltage to a level at or above the charge voltage.
Example 4 includes the apparatus of Example 3, wherein: the control circuit is configured to monitor a power output of the power adapter; and the control circuit is configured to request that power adapter maintain its power output above a required power supply of one or more circuits.
Example 5 includes the apparatus of any one of Examples 2-4, further comprising: one or more processors coupled to the battery charger and the control circuit, wherein the control circuit is configured to reduce a frequency of the one or more processors in response to the temperature sensed by the temperature sensor exceeding the threshold.
Example 6 includes the apparatus of any one of Examples 2-5, wherein the threshold is a skin temperature threshold.
Example 7 includes the apparatus of any one of Examples 2-6, wherein the battery charger comprises a voltage regulator configured to operate in a buck mode in response to the power adapter decreasing its output voltage.
Example 8 includes the apparatus of any one of Examples 2-7, wherein to request that the power adapter decrease its output voltage, the control circuit is configured to renegotiate a power contract with the power adapter.
Example 9 includes the apparatus of Example 8, wherein to renegotiate the power contract, the control circuit is configured to select a power data object among a plurality of available power data objects of the power adapter.
Example 10 includes the apparatus of Example 8, wherein to renegotiate the power contract, the control circuit is configured to select a desired level of the output voltage according to at least one of a programmable power supply (PPS) or adjustable voltage supply (AVS) protocol of the power adapter.
Example 11 includes the apparatus of any one of Examples 1-10, wherein the control circuit includes a feedback loop with an adder to receive an average measured power consumption, a proportional-integral-derivative (PID) controller coupled to the adder, an adjustment circuit coupled to the PID controller to adjust an output of the PID controller, and a scaler including an input coupled to the adjustment circuit and configured to convert a voltage into a power, and an output coupled to the adder.
Example 12 includes the apparatus of any one of Examples 1-11, wherein the battery charger, the control circuit, the temperature sensor and the charge-level detector are provided in a computing device, and the power adapter is external to the computing device.
Example 13 includes a system, comprising: a power delivery (PD) controller coupled to a Universal Serial Bus (USB) port; a battery charger coupled to the PD controller; an embedded power controller (EPC) coupled to the PD controller; and a skin temperature sensor coupled to the EPC, wherein the EPC is to request that the PD controller renegotiate a power contract with an external adapter that is coupled to the USB port in response to a temperature sensed by the skin temperature sensor exceeding a threshold, and the renegotiation is to reduce a voltage input to the battery charger.
Example 14 includes the system of Example 13, further comprising a charge-level detector, wherein the renegotiation is based on charge voltage of the battery determined by the charge-level detector.
Example 15 includes the system of Example 13 or 14, wherein the EPC is to reduce a frequency of one or more processors coupled to the battery charger in response to the temperature sensed by the skin temperature sensor exceeding the threshold.
Example 16 includes the system of any one of Examples 13-15, further comprising a power measurement circuit, wherein the renegotiation is based on an input power to the battery charger as measured by the power measurement circuit.
Example 17 includes a non-transitory computer-readable medium, comprising instructions configured to be executed by a processor to: determine that a skin temperature of a computing device exceeds a threshold, wherein the computing device includes a battery charger and a battery; determine a charge voltage of the battery; determine a power consumption of the computing device; and reduce an input voltage to the battery charger based on the skin temperature, the charge voltage and the power consumption.
Example 18 includes the non-transitory computer-readable medium of Example 17, wherein the reducing of the input voltage maintains a buck mode of a voltage regulator of the battery charger.
Example 19 includes the non-transitory computer-readable medium of Example 17 or 18, wherein the reducing of the input voltage maintains the power consumption above a required power supply of the computing device.
Example 20 includes the non-transitory computer-readable medium of any one of Examples 17-19, wherein the reducing of the input voltage includes renegotiating a power contract with an alternating current (AC)-to-direct current (DC) adapter.
Example 21 includes a method, comprising: determining that a skin temperature of a computing device exceeds a threshold; in response to the skin temperature exceeding the threshold, requesting a decrease in an output voltage of a power adapter which provides power to the computing device.
Example 22 includes the method of Example 21, further comprising: monitoring a charge level of a battery of the computing device, and requesting that the power adapter decrease its output voltage to a level at or above the charge voltage.
Example 23 includes the method of Example 21 or 22, further comprising: monitoring a power output of the power adapter, and requesting that power adapter maintain its power output above a required power supply of one or more circuits of the computing device.
Example 24 includes an apparatus, comprising means to perform the method of any one of Examples 21-23.
Example 25 includes a machine-readable storage including machine-readable instructions which, when executed, cause a computer to implement the method of any one of Examples 21-23.
Example 26 includes a computer program comprising instructions which, when executed by a computer, cause the computer to carry out the method of any one of Examples 21-23.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a battery charger including an input coupled to a power adapter;
a control circuit coupled to the battery charger and the power adapter;
a temperature sensor coupled to the control circuit; and
a charge-level detector coupled to a battery and to the control circuit.

2. The apparatus of claim 1, wherein the control circuit is configured to request that the power adapter decrease its output voltage in response to a temperature sensed by the temperature sensor exceeding a threshold.

3. The apparatus of claim 2, wherein:
the charge-level detector is configured to monitor a charge voltage of the battery; and
the control circuit is configured to request that power adapter decrease its output voltage to a level at or above the charge voltage.

4. The apparatus of claim 3, wherein:
the control circuit is configured to monitor a power output of the power adapter; and
the control circuit is configured to request that power adapter maintain its power output above a required power supply of one or more circuits.

5. The apparatus of claim 2, further comprising:
one or more processors coupled to the battery charger and the control circuit, wherein the control circuit is configured to reduce a frequency of the one or more processors in response to the temperature sensed by the temperature sensor exceeding the threshold.

6. The apparatus of claim 2, wherein the threshold is a skin temperature threshold.

7. The apparatus of claim 2, wherein the battery charger comprises a voltage regulator configured to operate in a buck mode in response to the power adapter decreasing its output voltage.

8. The apparatus of claim 2, wherein to request that the power adapter decrease its output voltage, the control circuit is configured to renegotiate a power contract with the power adapter.

9. The apparatus of claim 8, wherein to renegotiate the power contract, the control circuit is configured to select a power data object among a plurality of available power data objects of the power adapter.

10. The apparatus of claim 8, wherein to renegotiate the power contract, the control circuit is configured to select a desired level of the output voltage according to at least one of a programmable power supply (PPS) or adjustable voltage supply (AVS) protocol of the power adapter.

11. The apparatus of claim 1, wherein the control circuit includes a feedback loop with an adder to receive an average measured power consumption, a proportional-integral-derivative (PID) controller coupled to the adder, an adjustment circuit coupled to the PID controller to adjust an output of the PID controller, and a scaler including an input coupled to the adjustment circuit and configured to convert a voltage into a power, and an output coupled to the adder.

12. The apparatus of claim 1, wherein the battery charger, the control circuit, the temperature sensor and the charge-level detector are provided in a computing device, and the power adapter is external to the computing device.

13. A system, comprising:
a power delivery (PD) controller coupled to a Universal Serial Bus (USB) port;
a battery charger coupled to the PD controller;
an embedded power controller (EPC) coupled to the PD controller; and
a skin temperature sensor coupled to the EPC, wherein the EPC is to request that the PD controller renegotiate a power contract with an external adapter that is coupled to the USB port in response to a temperature sensed by the skin temperature sensor exceeding a threshold, and the renegotiation is to reduce a voltage input to the battery charger.

14. The system of claim 13, further comprising a charge-level detector, wherein the renegotiation is based on charge voltage of the battery determined by the charge-level detector.

15. The system of claim 13, wherein the EPC is to reduce a frequency of one or more processors coupled to the battery charger in response to the temperature sensed by the skin temperature sensor exceeding the threshold.

16. The system of claim 13, further comprising a power measurement circuit, wherein the renegotiation is based on an input power to the battery charger as measured by the power measurement circuit.

17. A non-transitory computer-readable medium, comprising instructions configured to be executed by a processor to:
determine that a skin temperature of a computing device exceeds a threshold, wherein the computing device includes a battery charger and a battery;
determine a charge voltage of the battery;
determine a power consumption of the computing device; and
reduce an input voltage to the battery charger based on the skin temperature, the charge voltage and the power consumption.

18. The non-transitory computer-readable medium of claim 17, wherein the reducing of the input voltage maintains a buck mode of a voltage regulator of the battery charger.

19. The non-transitory computer-readable medium of claim 17, wherein the reducing of the input voltage maintains the power consumption above a required power supply of the computing device.

20. The non-transitory computer-readable medium of claim 17, wherein the reducing of the input voltage includes renegotiating a power contract with an alternating current (AC)-to-direct current (DC) adapter.
